(19) United States
(12) Patent Application Publication
(10) Pub. No.: US 2022/0161356 A1
(43) Pub. Date: May 26, 2022

(54) LASER PROCESSING SYSTEM AND JIG

(71) Applicant: Panasonic Intellectual Property Management Co., Ltd., Osaka (JP)

(72) Inventors: KAZUKI FUJIWARA, Osaka (JP); KOJI FUNAMI, Kyoto (JP)

(21) Appl. No.: 17/512,637

(22) Filed: Oct. 27, 2021

(30) Foreign Application Priority Data
Nov. 24, 2020 (JP) 2020-194458

(51) Int. Cl. B23K 26/06; B23K 26/70; B23K 26/10; B23K 26/21

(52) U.S. Cl. CPC B23K 26/0643; B23K 26/705; B23K 26/21; B23K 26/0665; B23K 26/10; B23K 26/0648

(57) ABSTRACT

A laser processing system includes a laser oscillator that forms a fusion zone in a workpiece by irradiating a fusion-scheduled region of a processing target surface of the workpiece with a laser beam, a photometer that measures intensity of light from the fusion zone of the workpiece, and a jig disposed on the processing target surface of the workpiece not to overlap the fusion-scheduled region in order to press the workpiece. The jig has a reflection surface inclined in a manner that the reflection surface is further away from the fusion-scheduled region as the reflection surface is further away from the processing target surface in a normal direction of the processing target surface of the workpiece.

### BACKGROUND

### 1. Technical Field

The present disclosure generally relates to a laser processing system and a jig. The present disclosure particularly relates to a laser processing system and a jig by which laser processing can be evaluated.

### 2. Description of the Related Art

According to a laser welding technology which is a type of laser processing, a workpiece is irradiated with a laser beam output from a laser oscillator, and a portion of the workpiece is fused with a quantity of heat of the laser beam to weld the workpiece to another workpiece. In this manner, the technology enables the workpieces to be mechanically and electrically connected to each other. The laser welding technology is generally used in a various fields of home appliances, precision instruments, or automobile components.

In the laser welding technology, various adjustment items are generally adjusted using a trial-and-error method in accordance with a shape or a size of an individual laser oscillator or an individual workpiece. However, when the workpiece having desired quality cannot be obtained, adjustment using the trial-and-error method cannot satisfy the desired quality in some cases.

Japanese Patent Unexamined Publication No. 2017-164801 discloses a laser processing system. The laser processing system disclosed in Japanese Patent Unexamined Publication No. 2017-164801 includes a state quantity observer that observes a state quantity of the laser processing system, an operation result acquirer that acquires a processing result of the laser processing system, a learner that performs learning by receiving an output from the state quantity observer and an output from operation result acquirer so that a laser processing condition data is associated with the state quantity and processing result of the laser processing system, and a decision maker that outputs the laser processing condition data with reference to the laser processing condition data learned by the learner.

### SUMMARY

According to an aspect of the present disclosure, there is provided a laser processing system including a laser oscillator that forms a fusion zone in a workpiece by irradiating a fusion-scheduled region on a processing target surface of the workpiece with a laser beam, a photometer that measures intensity of light from the fusion zone of the workpiece, and a jig disposed on the processing target surface of the workpiece not to overlap the fusion-scheduled region. The jig has a reflection surface inclined in a manner that the reflection surface is further away from the fusion-scheduled region as the reflection surface is further away from the processing target surface in a normal direction of the processing target surface of the workpiece.

According to another aspect of the present disclosure, there is provided a jig disposed on a processing target surface of a workpiece not to overlap a fusion-scheduled region, in laser processing for forming a fusion zone on the workpiece by irradiating the fusion-scheduled region of the processing target surface of the workpiece with a laser beam. The jig has a reflection surface inclined in a manner that the reflection surface is further away from the fusion-scheduled region as the reflection surface is further away from the processing target surface in a normal direction of the processing target surface of the workpiece.

### BRIEF DESCRIPTION OF THE DRAWINGS

FIG. 1 is a block diagram of a configuration example of a laser processing system according to an embodiment;

FIG. 2 is a view for describing a behavior of light from a fusion zone in the laser processing system in FIG. 1;

FIG. 3 is a view for describing a relationship between a jig and a condenser lens in the laser processing system in FIG. 1;

FIG. 4 is a schematic view of a configuration example of the jig of the laser processing system in FIG. 1;

FIG. 5 is a graph illustrating a relationship of a time change in intensity of the light from the fusion zone with respect to an output of a laser beam;

FIG. 6 is a schematic cross-sectional view of a configuration example of a jig of Modification Example 1;

FIG. 7 is a schematic cross-sectional view of a configuration example of a jig of Modification Example 2;

FIG. 8 is a schematic view of a configuration example of a jig of Modification Example 3; and

FIG. 9 is a schematic view of a configuration example of a jig of Modification Example 4.

### DETAILED DESCRIPTIONS

In a laser processing system as disclosed in Japanese Patent Unexamined Publication No. 2017-164801, when a processing result of the laser processing system is evaluated, light from a workpiece irradiated with a laser beam is measured while laser processing is performed by irradiating the workpiece with the laser beam. When the laser processing is low output processing or fine processing, it is preferable that laser processing conditions are constant as much as possible so that the processing conditions do not fluctuate. Furthermore, when the light from the workpiece is measured, it is preferable that intensity of emission light and scattered light from the workpiece can sufficiently be secured.

The present disclosure provides a laser processing system and a jig by which laser processing can stably be performed and accuracy in evaluating the laser processing can be improved.

### EMBODIMENTS

### 1-1 Overview

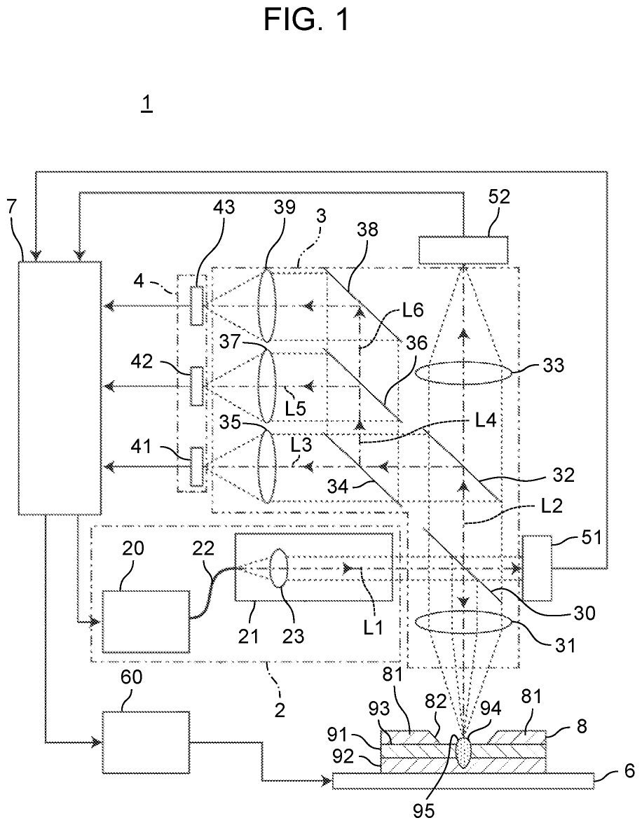

FIG. 1 is a block diagram of a configuration example of laser processing system 1 according to an embodiment. Laser processing system 1 performs processing of workpiece 91 by irradiating workpiece 91 with laser beam L1. In FIG. 1, laser processing system 1 is used for laser welding in which workpiece 91 is joined to another workpiece 92. Workpiece 92 is disposed below workpiece 91. Workpiece 91 is irradiated with laser beam L1, and a portion of workpiece 91 and a portion of workpiece 92 are fused to form fusion zone 94. In this manner, workpiece 91 and workpiece 92 are fused and joined to each other.

As illustrated in FIG. 1, laser processing system 1 includes laser oscillator 20, photometer 4, and jig 8. Laser oscillator 20 forms fusion zone 94 on workpiece 91 by irradiating fusion-scheduled region 95 of processing target surface 93 of workpiece 91 with laser beam L1. When fusion-scheduled region 95 of processing target surface 93 of workpiece 91 is irradiated with laser beam L1, fusion zone 94 is formed, and light L2 is emitted from fusion zone 94. Photometer 4 measures intensity of light L2 emitted from fusion zone 94 of workpiece 91. Jig 8 is disposed on processing target surface 93 of workpiece 91 in order to press workpiece 91. Jig 8 has reflection surface 82 inclined away from fusion-scheduled region 95 as reflection surface 82 is away from processing target surface 93 of workpiece 91.

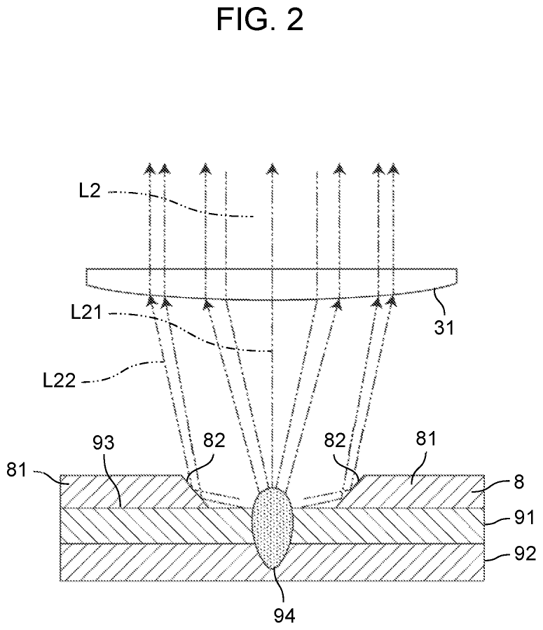

In laser processing system 1 in FIG. 1, jig 8 is disposed on processing target surface 93 of workpiece 91 not to overlap fusion-scheduled region 95 in order to press workpiece 91. Since jig 8 is used, unintended misalignment of an irradiation position of laser beam L1 on workpiece 91 is reduced, and stable laser processing can be performed. Jig 8 has reflection surface 82 inclined away from fusion-scheduled region 95 as reflection surface 82 is directed in a normal direction of processing target surface 93 of workpiece 91. As illustrated in FIG. 2, a quantity of light incident on photometer 4 out of light L2 emitted from fusion zone 94 can be increased by reflection surface 82. In this manner, accuracy in evaluating the laser processing can be improved.

### 1-2 Detailed Configuration

Hereinafter, laser processing system 1 in FIG. 1 will be described in more detail. Laser processing system 1 includes laser irradiation system 2, optical system 3, photometer 4, laser output sensor 51, camera 52, stage 6, movement device 60, processing device 7, and jig 8.

### 1-2-1. Laser Irradiation System

In FIG. 1, laser irradiation system 2 irradiates workpiece 91 with laser beam L1 to perform the laser processing of workpiece 91. Laser irradiation system 2 includes laser oscillator 20, optical column 21, laser transmission fiber 22, and collimator lens 23.

Laser oscillator 20 outputs laser beam L1 for performing the laser processing of workpiece 91. For example, laser oscillator 20 is a fiber laser. For example, a wavelength of laser beam L1 is 1,070 nm. The wavelength of laser beam L1 is appropriately set in view of light absorption characteristics of workpiece 91. For example, when a material of workpiece 91 is copper or gold, the wavelength of the laser L1 is set to a short wavelength of 405 to 450 nm. For example, when the material of workpiece 91 is aluminum, the wavelength of the laser L1 is set to approximately 800 nm. Since the aluminum enables the wavelength to have satisfactory light absorption characteristics, satisfactory welding can be performed. Laser beam L1 may be a continuous wave, or may be a pulse wave. When laser beam L1 is the continuous wave, a quantity of heat input to workpiece 91 can be increased. Accordingly, productivity is improved, and laser welding can be performed. When laser beam L1 is the pulse wave, a thermal effect during the laser processing can be reduced, compared to a case where laser beam L1 is the continuous wave.

In laser irradiation system 2 in FIG. 1, laser beam L1 output from laser oscillator 20 is transmitted to optical column 21 via laser transmission fiber 22. Laser beam L1 output from laser transmission fiber 22 is converted into parallel light by collimator lens 23 inside optical column 21, and is output to optical system 3.

### 1-2-2. Optical System

Optical system 3 defines an optical path among laser irradiation system 2, photometer 4, laser output sensor 51, and camera 52. In particular, optical system 3 includes condenser lens 31 that faces processing target surface 93 of workpiece 91. Optical system 3 causes condenser lens 31 to condense laser beam L1 from laser oscillator 20 on fusion-scheduled region 95 by, and to direct the light incident on condenser lens 31 out of light L2 from fusion zone 94 to photometer 4. More specifically, optical system 3 includes mirrors 30, 32, 34, 36, and 38 and condenser lenses 31, 33, 35, 37, and 39.

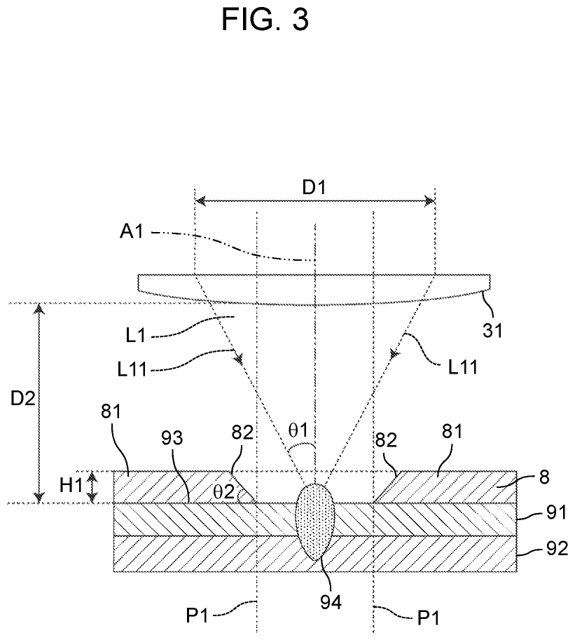

As illustrated in FIG. 1, mirror 30 reflects a portion of laser beam L1 from laser irradiation system 2 toward fusion-scheduled region 95 of workpiece 91. The remaining portion is transmitted therethrough, and is incident on laser output sensor 51. For example, mirror 30 is a beam splitter. A ratio of the light transmitted through mirror 30 and the light reflected by mirror 30 is appropriately set. As illustrated in FIGS. 1 and 3, condenser lens 31 faces processing target surface 93 of workpiece 91. Condenser lens 31 condenses laser beam L1 reflected by mirror 30 on fusion-scheduled region 95 of workpiece 91. As illustrated in FIG. 3, condenser lens 31 is disposed to correspond to a region (fusion-scheduled region 95) in which optical axis A1 of condenser lens 31 serves as fusion zone 94. Condenser lens 31 is disposed so that a focal position of laser beam L1 is located on processing target surface 93 of workpiece 91. In this way, fusion-scheduled region 95 of workpiece 91 is irradiated with laser beam L1 from laser irradiation system 2 to form fusion zone 94 in workpiece 91. In this way, optical system 3 guides laser beam L1 to fusion-scheduled region 95 of workpiece 91. Optical system 3 guides laser beam L1 to laser output sensor 51.

When fusion-scheduled region 95 of processing target surface 93 of workpiece 91 is irradiated with laser beam L1, fusion zone 94 is formed, and light L2 is emitted from fusion zone 94. In optical system 3 in FIG. 1, light L2 from fusion zone 94 of workpiece 91 is transmitted through condenser lens 31 and mirror 30, and is incident on mirror 32. Mirror 32 reflects a portion of light L2 from fusion zone 94 of workpiece 91 toward mirror 34, and the remaining portion is transmitted therethrough. For example, mirror 32 is a beam splitter such as a half mirror. A ratio of the light transmitted through mirror 32 and the light reflected by mirror 30 is appropriately set. Condenser lens 33 condenses light L2 transmitted through mirror 32 on a light receiver of camera 52. In this way, optical system 3 guides light L2 from fusion zone 94 of workpiece 91 to camera 52.

Light L3 having a specific wavelength band out of light L2 from fusion zone 94 of workpiece 91 is transmitted through mirror 34, and is incident on condenser lens 35. Mirror 34 reflects remaining light L4 toward mirror 36. For example, mirror 34 is a dichroic mirror. For example, light L3 is visible light, and the specific wavelength band of mirror 34 is 400 to 700 nm, for example. Mirror 34 may be selected depending on a wavelength to be transmitted, and a ratio of the quantity of the light to be transmitted and reflected may be changed when necessary. Condenser lens 35 condenses light L3 transmitted through mirror 34 on a light receiver of optical sensor 41 (to be described later) of photometer 4. Light L5 having a specific wavelength band out of light L4 reflected by mirror 34 is reflected by mirror 36, and is incident on condenser lens 37. Remaining light L6 is transmitted toward mirror 38. For example, mirror 36 is a dichroic mirror. For example, light L5 is thermal radiation light generated in fusion zone 94, and the specific wavelength band of mirror 36 is 1,300 to 1,550 nm, for example. Condenser lens 37 condenses light L5 reflected by mirror 36 on optical sensor 42 (to be described later) of photometer 4. Light L6 transmitted through mirror 36 is reflected by mirror 38, and is incident on condenser lens 39. For example, the wavelength band of light L1 includes the wavelength of laser beam L1. Condenser lens 39 condenses light L6 reflected by mirror 38 on optical sensor 43 (to be described later) of photometer 4. In this way, optical system 3 guides light L2 from fusion zone 94 of workpiece 91 to photometer 4. More specifically, optical system 3 divides light L2 from fusion zone 94 of workpiece 91 into light L3, L5, and L6 having different wavelength bands, and respectively guides light L3, L5, and L6 to optical sensors 41, 42, and 43 of photometer 4.

In order to select the wavelength, optical system 3 in FIG. 1 includes each bandpass filter between mirror 34 and optical sensor 41, between mirror 36 and optical sensor 42, and between mirror 38 and optical sensor 43. The bandpass filter prevents the light having an unnecessary wavelength band from being incident on optical sensors 41, 42, and 43, and enables more accurate measurement of the light.

### 1-2-3. Photometer

Photometer 4 measures intensity of light L2 from fusion zone 94 of workpiece 91, and outputs an intensity signal indicating the measured intensity of light L2 to processing device 7. The intensity signal is not particularly limited, but is a voltage signal, for example. Light L2 from fusion zone 94 may include the light having various wavelength bands. For example, light L2 from fusion zone 94 may include at least one of thermal radiation light caused by fusion of workpiece 91 irradiated with laser beam L1, excitation light caused by excitation of workpiece 91 irradiated with laser beam L1, laser plasma generated by irradiation with laser beam L1, and reflection light of laser beam L1 reflected by workpiece 91. Photometer 4 in FIG. 1 includes three optical sensors 41, 42, and 43 in order to individually measure the intensity of the light having various wavelength bands which can be included in light L2 from fusion zone 94.

As described above, optical sensor 41 receives light L3 from optical system 3. Light L3 is light having a specific wavelength band out of light L2 from fusion zone 94 of workpiece 91. In laser processing system 1 in FIG. 1, light L3 is visible light. Optical sensor 41 measures the intensity of the visible light, and outputs the intensity signal indicating the measured intensity of visible light to processing device 7. As described above, optical sensor 42 receives light L5 from optical system 3. Light L5 is light having a specific wavelength band out of light L2 from fusion zone 94 of workpiece 91. In laser processing system 1 in FIG. 1, light L5 is the thermal radiation light. Optical sensor 42 measures the intensity of the thermal radiation light, and outputs the intensity signal indicating the intensity of the measured thermal radiation light to processing device 7. As described above, optical sensor 43 receives light L6 from optical system 3. Light L6 is included in light L2 from fusion zone 94 of workpiece 91. In laser processing system 1 in FIG. 1, optical sensor 43 measures the intensity of the light having the wavelength equal to that of laser beam L1 out of light L6, and outputs the intensity signal indicating the measured intensity of the light to processing device 7.

For example, optical sensors 41, 42, and 43 are photodetectors including a photodiode. The photodetector is set to have high sensitivity to the wavelength band of the light to be measured. For example, a measurement resolution is set so that the measurement can be performed with accuracy of 1/100 or less of a shape to be measured. Each measurement region of optical sensors 41, 42, and 43 is set to include whole fusion zone 94 at least in a width direction of fusion zone 94.

As a method of changing the measurement region, a method of adjusting each focal length of condenser lenses 31, 35, 37, and 39 may be used. When a size of a light receiver of optical sensors 41, 42, and 43 is defined as ds [mm], a size of the measurement region of optical sensors 41, 42, and 43 is defined as dm [mm], a focal length of condenser lens 31 is defined as f1 [mm], and a focal length of condenser lenses 35, 37, and 39 is defined as f2 [mm], dm=ds×f1/f2 is satisfied. For example, when f1 is 200 mm and f2 is 100 mm, the measurement region is twice the size of the light receiver. Since focal lengths f1 and f2 are adjusted in this way, size dm of the measurement region can be adjusted. A measurable region may be limited by providing optical sensors 41, 42, and 43 with apertures capable of changing an opening diameter.

### 1-2-4. Laser Output Sensor

As illustrated in FIG. 1, laser output sensor 51 measures an output of laser beam L1 from laser irradiation system 2, and outputs an output signal indicating the output of laser beam L1 to processing device 7. The laser output sensor 51 in FIG. 1 measures an output of the light of laser beam L1 transmitted through mirror 30. There is a correlation between the output of laser beam L1 transmitted through mirror 30 and the output of laser beam L1 before being incident on mirror 30. Accordingly, the output of laser beam L1 before being incident on mirror 30 can be obtained from the output of laser beam L1 transmitted through mirror 30. When the output of laser beam L1 transmitted through mirror 30 exceeds a measurement range of laser output sensor 51, an optical element that attenuates laser beam L1 may be disposed between mirror 30 and laser output sensor 51. In order to reduce the reflection of laser beam L1 on a surface of laser output sensor 51 or an optical element, laser output sensor 51 or the optical element may be disposed to be inclined with respect to an optical axis of laser beam L1 transmitted through mirror 30.

### 1-2-5. Camera

Camera 52 acquires an image around fusion zone 94 of workpiece 91, and outputs the acquired image to processing device 7. As described above, camera 52 receives light L2 from fusion zone 94 of workpiece 91 from optical system 3. For example, a sampling cycle (measurement cycle) of camera 52 is set to 1/100 or less of a time for controlling an output of laser irradiation. The image acquired by camera 52 is used for detecting a state of emission light and reflection light of fusion zone 94.

### 1-2-6. Stage

Stage 6 supports workpiece 91 for the laser processing. In FIG. 1, workpiece 92 is installed below workpiece 91. Workpiece 91 and workpiece 92 are disposed on stage 6. In laser processing system 1 in FIG. 1, workpiece 91 and workpiece 92 are held on stage 6 by jig 8.

### 1-2-7. Movement Device

Movement device 60 moves stage 6 to move an irradiation position of workpiece 91 irradiated with laser beam L1 from laser irradiation system 2. Movement device 60 includes a power source such as a motor, and moves stage 6. As stage 6 is moved, workpiece 91 and workpiece 92 are also moved. In FIG. 1, the movement device 60 linearly moves stage 6 along a direction orthogonal to a paper surface in FIG. 1. Laser processing system 1 in FIG. 1 irradiates workpiece 91 with laser beam L1 in synchronization with the movement of stage 6. In this manner, workpiece 91 and workpiece 92 are joined to each other by laser welding.

### 1-2-8. Jig

As illustrated in FIGS. 1 to 3, jig 8 is disposed on processing target surface 93 of workpiece 91 in order to press workpiece 91, in the laser processing for forming fusion zone 94 in workpiece 91 by irradiating fusion-scheduled region 95 of processing target surface 93 of workpiece 91 with laser beam L1. For example, a material of jig 8 is a material having a high melting point such as metal, in view of spatter generated by irradiation with laser beam L1.

Jig 8 is used for pressing workpiece 91 so that the irradiation position of laser beam L1 is not misaligned or a position or a shape of workpiece 91 is not changed during the laser processing. For example, as illustrated in FIG. 1, when workpieces 91 and 92 are superposed on and welded to each other, workpieces 91 and 92 can be prevented from floating at the irradiation position of laser beam L1 by a position where jig 8 is placed. Even when workpieces 91 and 92 are not superposed on and welded to each other, there is an advantageous effect in suppressing the misalignment of workpieces 91. Accordingly, jig 8 is effectively used for the laser processing. Since jig 8 is used, unintended misalignment of an irradiation position of laser beam L1 on workpiece 91 is reduced, and stable laser processing can be performed.

FIG. 2 is a view for describing a behavior of light L2 from fusion zone 94 in laser processing system 1 in FIG. 1. When workpiece 91 is irradiated with laser beam L1, fusion zone 94 is formed. For example, when workpiece 91 is metal, thermal radiation light, emission light peculiar to the metal, emission light caused by plasma are generated in fusion zone 94 due to a temperature rise. Furthermore, all of laser beam L1 does not contribute to the laser processing, and a portion of laser beam L1 is reflected by fusion zone 94 as return light.

When light L2 from fusion zone 94 is measured on a real-time basis during the laser processing, light L2 from fusion zone 94 may include the thermal radiation light, the visible light, the excitation light, the laser plasma, and the reflection light. The intensity of light L2 from fusion zone 94 is important information that reflects a state of fusion zone 94 such as a change in a shape of fusion zone 94. For example, since the thermal radiation light, the visible light, the excitation light, the laser plasma, and the reflection light are measured on the real-time basis, it is possible to acquire the intensity of the light according to the shape of fusion zone 94 corresponding to laser processing conditions.

For example, when the shape of fusion zone 94 is suddenly changed in a direction opposite to an incident direction of laser beam L1 incident on workpiece 91, a component of the reflection light in fusion zone 94 or a component of the emission light in fusion zone 94 is also greatly changed due to a change in the shape of fusion zone 94. For example, when a width or a length of fusion zone 94 is changed, the intensity of light L2 from fusion zone 94 is changed in accordance with the changed width or the changed length of fusion zone 94. That is, the intensity of light L2 from fusion zone 94 is also changed in accordance with a change in a fusion area of fusion zone 94. For example, when a focal position of laser beam L1 is changed, a spot diameter at the irradiation position of workpiece 91 irradiated with laser beam L1 is changed. When the focal position of laser beam L1 is changed and the spot diameter increases from a just focus time at which the focal position of laser beam L1 is aligned with fusion-scheduled region 95 of workpiece 91, a welding area of fusion zone 94 also increases. In this manner, light L2 from fusion zone 94 also increases.

Since this fact is utilized, it is possible to estimate the shape of fusion zone 94 from the intensity of light L2 from fusion zone 94, or it is possible to recognize that there is a difference between a current shape of fusion zone 94 and an originally desired processing shape.

For example, light L2 is stored by measurement or calculation during the laser processing with a desired fusion width, and is compared with light L2 during actual laser processing. In this manner, it is possible to more precisely recognize a state of the laser processing.

For example, processed fusion zone 94 is measured, measurement is performed, based on a processing result, and the intensity of light L2 and a measurement value of the width of fusion zone 94 are associated with each other. In this manner, it is possible to detect a measurement result based on the fusion area.

In general, the shape of fusion zone 94 greatly affects joining strength obtained by laser welding. Accordingly, when the shape of fusion zone 94 can accurately be measured, defects such as joint disconnection during the laser welding can be reduced, thereby enabling quality of products to be stabilized.

In general, when workpiece 91 is metal, the output of laser beam L1 needs to be several tens to several kW for the welding, although the output depends on an absorption rate of the material of workpiece 91 at the wavelength of laser beam L1 or an irradiation condition of laser beam L1. In particular, when the welding is performed with laser beam L1 having a low output, the quantity of light L2 from fusion zone 94 decreases as the output of laser beam L1 is reduced. Therefore, a light emitting state of fusion zone 94 is less likely to be detected.

Therefore, the quantity of the light incident on photometer 4 out of light L2 from fusion zone 94 is increased. In this manner, it is possible to more accurately recognize a fusion state of fusion zone 94, and accuracy in evaluating the laser processing can be improved.

As illustrated in FIG. 2, light L2 from fusion zone 94 does not have directivity as in the laser. Although light L2 depends on the shape of fusion zone 94, light L2 spreads from fusion zone 94 in an isotropic manner. For example, light L2 from fusion zone 94 includes light L21 traveling in a direction in which light L2 reaches photometer 4 and light L22 traveling in a direction in which light L22 cannot reach photometer 4 without jig 8. For example, light L21 travels in a direction opposite to a direction of the optical axis of laser beam L1, and is incident on condenser lens 31. For example, without jig 8, light L22 travels in a direction intersecting with the direction of the optical axis of laser beam L1, and is not incident on condenser lens 31.

As illustrated in FIGS. 1 to 3, Jig 8 has reflection surface 82. Reflection surface 82 is a tapered surface inclined away from fusion-scheduled region 95 as reflection surface 82 is directed in the normal direction of processing target surface 93 of workpiece 91. More specifically, reflection surface 82 is inclined away from fusion-scheduled region 95 in a surface direction of processing target surface 93 as reflection surface 82 is away from processing target surface 93 in the normal direction of processing target surface 93 of workpiece 91. In FIG. 2, the normal direction of processing target surface 93 is a direction opposite to a traveling direction of laser beam L1. The surface direction of the processing target surface 93 is a direction orthogonal to the normal direction of the processing target surface 93. In other words, reflection surface 82 is inclined to reflect light L2 from fusion zone 94 toward condenser lens 31. As illustrated in FIG. 2, reflection surface 82 can reflect light L22, and can direct light L22 in the direction in which light L22 reaches photometer 4. Therefore, the quantity of the light incident on photometer 4 out of light L2 from fusion zone 94 can be increased. In this manner, accuracy in evaluating the laser processing can be improved.

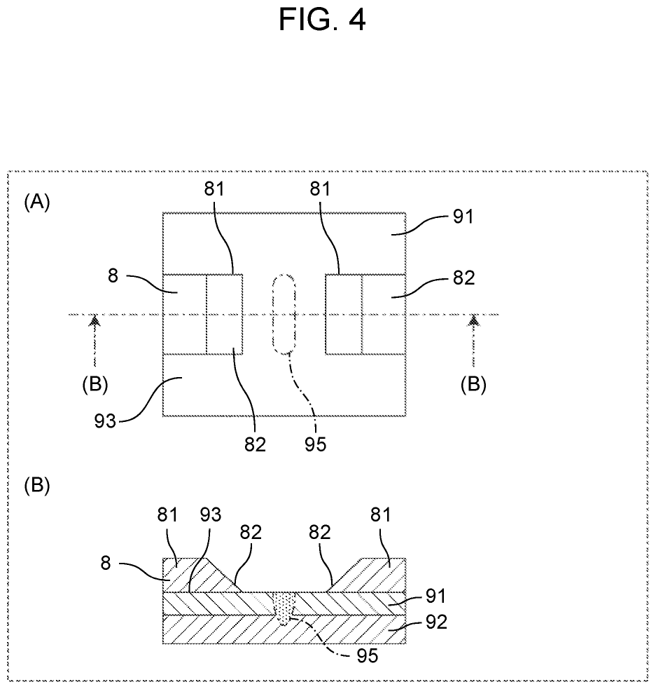

Hereinafter, a configuration of jig 8 will be described in detail. FIG. 4 is a schematic view of a configuration example of jig 8. (A) of FIG. 4 is a plan view illustrating a state where jig 8 is disposed on processing target surface 93 of workpiece 91. (B) of FIG. 4 is a cross-sectional view taken along line IVB-IVB in (A) of FIG. 4.

Jig 8 is disposed on processing target surface 93 not to overlap fusion-scheduled region 95 that forms fusion zone 94. Therefore, jig 8 is formed to have a shape of pressing workpiece 91 around fusion-scheduled region 95 of processing target surface 93. On the other hand, when reflection surface 82 is closer to fusion zone 94, the quantity of the light incident on photometer 4 out of light L2 from fusion zone 94 can be increased. However, when reflection surface 82 is excessively close to fusion zone 94, in a case where the width of fusion zone 94 fluctuates, laser beam L1 may touch reflection surface 82. Therefore, reflection surface 82 is disposed while fusion-scheduled region 95 is separated by a predetermined distance so that laser beam L1 is not incident on reflection surface 82. For example, the predetermined distance is 1 mm or longer.

As illustrated in FIG. 4, jig 8 has a pair of pressers 81. The pair of pressers 81 are located on both sides of fusion-scheduled region 95 of processing target surface 93 of workpiece 91. In FIG. 4, fusion-scheduled region 95 has a linear shape. Fusion-scheduled region 95 is set when line processing such as line welding is performed by using laser beam L1. In FIG. 4, the pair of pressers 81 are located on both sides of fusion-scheduled region 95 in the width direction. A surface of each of the pair of pressers 81 on a side of fusion-scheduled region 95 includes reflection surface 82. In FIG. 4, presser 81 has a rectangular plate shape extending along fusion-scheduled region 95. The pair of pressers 81 are parallel to each other. One of both side surfaces of presser 81 in the width direction is reflection surface 82. Presser 81 is disposed on processing target surface 93 while reflection surface 82 faces fusion-scheduled region 95. Reflection surfaces 82 of the pair of pressers 81 face each other. A distance between reflection surfaces 82 of the pair of pressers 81 increases away from processing target surface 93 in the normal direction of processing target surface 93. In FIG. 4, reflection surface 82 is an inclined surface inclined at a constant angle. When an angle of reflection surface 82 is 1 degree or larger, there is a possibility that light L2 from fusion zone 94 may be incident on photometer 4 through condenser lens 31. Reflection surface 82 specularly reflects light L2 from fusion zone 94. Surface roughness of reflection surface 82 is equal to or less than surface roughness of a mirror surface. For example, the surface roughness is evaluated by any one of arithmetic average roughness (Ra), a maximum height (Ry), ten-point average roughness (Rz), an unevenness average interval (Sm), a local peak average interval (S), and load length ratio (tp). Reflection surface 82 is obtained by mirror surface processing such as mirror polishing. The surface roughness of reflection surface 82 may be equal to or less than the surface roughness obtained by the mirror polishing.

FIG. 3 is a view for describing a relationship between jig 8 and condenser lens 31. In jig 8, reflection surface 82 faces a region within effective diameter D1 of condenser lens 31 in a direction along optical axis A1 of condenser lens 31. In this manner, the quantity of the light incident on photometer 4 out of light L2 from fusion zone 94 can be increased. In FIG. 4, whole reflection surface 82 faces the region within effective diameter D1 of condenser lens 31 in the direction along optical axis A1 of condenser lens 31. However, at least a portion of reflection surface 82 may face the region within effective diameter D1 of condenser lens 31 in the direction along optical axis A1 of condenser lens 31. That is, position P1 of a portion of reflection surface 82 which is closest to fusion-scheduled region 95 may be located inside the region within effective diameter D1 of condenser lens 31.

In FIG. 3, presser 81 is disposed so that reflection surface 82 faces the region within effective diameter D1 of condenser lens 31 in the direction along optical axis A1 of condenser lens 31. In this case, an angle of reflection surface 82 with respect to processing target surface 93 is set to reduce a possibility that laser beam L1 may touch reflection surface 82. As illustrated in FIG. 3, when an angle between optical axis A1 of condenser lens 31 and marginal ray L11 is defined as θ1 degree and an angle of reflection surface 82 with respect to processing target surface 93 is defined as θ2 degree, θ2<90−θ1 is satisfied. Marginal ray L11 is light that passes through a circumference defined by effective diameter D1 of condenser lens 31 out of laser beam L1. When θ2 satisfies θ2<90−θ1, a possibility that laser beam L1 may touch reflection surface 82 can be reduced. Height H1 of reflection surface 82 is equal to or smaller than working distance D2 of condenser lens 31. In FIG. 3, height H1 of reflection surface 82 is equal to a height of presser 81. In this case, when workpiece 91 is irradiated with laser beam L1, the irradiation position of laser beam L1 can be changed in accordance with the focal position of condenser lens 31. Therefore, condenser lens 31 and reflection surface 82 can be prevented from interfering with each other, when the irradiation position of laser beam L1 is changed.

### 1-2-9. Processing Device

As illustrated in FIG. 1, processing device 7 is connected to laser irradiation system 2, photometer 4, laser output sensor 51, camera 52, and movement device 60. Processing device 7 controls whole laser processing system 1. For example, processing device 7 is realized by a computer system including one or more processors (microprocessors) and one or more memories.

Processing device 7 performs the laser processing for forming fusion zone 94 by irradiating fusion-scheduled region 95 of workpiece 91 with laser beam L1 from laser oscillator 20. During the laser processing, processing device 7 controls laser oscillator 20 so that an output of laser beam L1 from laser irradiation system 2 reaches a predetermined target output. More specifically, processing device 7 controls laser oscillator 20 so that the intensity of laser beam L1 which is indicated by an output signal from laser output sensor 51 reaches the predetermined target output.

Processing device 7 performs an evaluation of the laser processing, based on the intensity of light L2 from fusion zone 94 which is measured by photometer 4. The evaluation of the laser processing includes estimating a fusion state of fusion zone 94, based on the intensity of light L2 from fusion zone 94 which is measured by photometer 4.

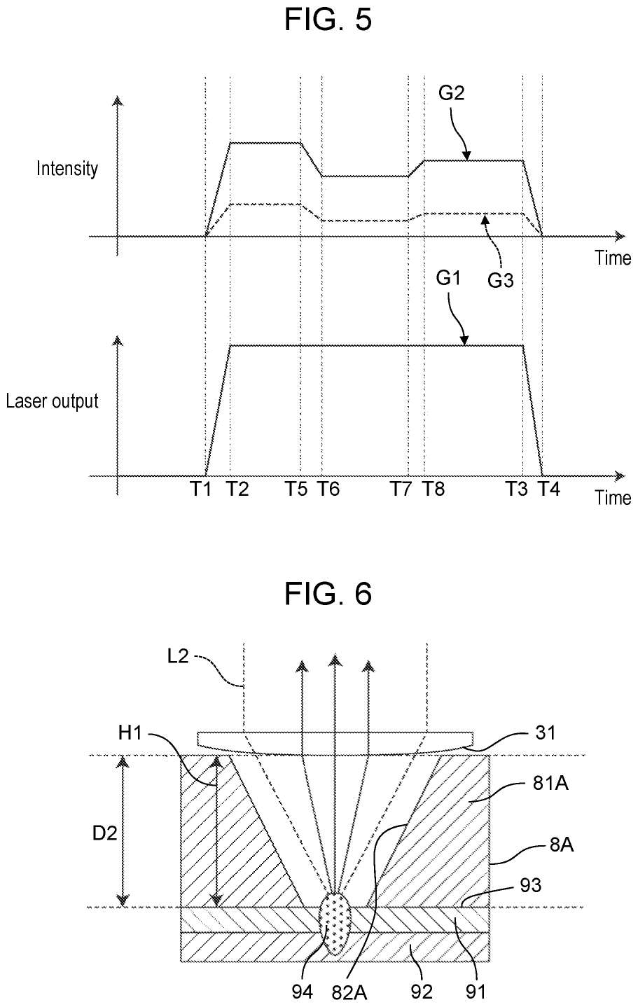

FIG. 5 is a graph illustrating a relationship of a time change in the intensity of light L2 from fusion zone 94 with respect to the output of laser beam L1. In FIG. 5, light L2 is the thermal radiation light.

In FIG. 5, G1 indicates an output profile which is a time change in the output of laser beam L1. The output profile of G1 is a trapezoidal waveform, and includes a slow-up portion (T1 to T2), a flat portion (T2 to T3), and a slow-down portion (T3 to T4). The slow-up portion and the slow-down portion are provided to prevent spattering or depression during the laser welding. Since a shape of the output profile is changed in accordance with the laser processing, it is possible to prevent spattering or depression.

G2 indicates an optical profile which is a time change in the intensity of light L2 from fusion zone 94 in laser processing system 1 in FIG. 1. G3 indicates an optical profile which is a time change in the intensity of light L2 from fusion zone 94 in a laser processing system according to a comparative example. The laser processing system according to the comparative example is different from laser processing system 1 in FIG. 1 in that jig 8 is not provided.

As can be understood from G1 to G3, as the output of laser beam L1 at times T1 to T2 increases, the intensity of the thermal radiation light also increases. When the output of laser beam L1 is stable, if fusion zone 94 is stably formed, a signal waveform is constant, or is proportional to an irradiation time amount, and the quantity of the light increases until a temperature is balanced. When there is an abnormality in fusion zone 94, the intensity of the thermal radiation light is changed even when the output of laser beam L1 is constant, as shown at times T5 to T6 or times T7 to T8. As the output of laser beam L1 at times T3 to T4 decreases, the intensity of the thermal radiation light also decreases. In this way, the optical profile of the thermal radiation light has a shape similar to the output profile of laser beam L1.

Here, the optical profile of G2 is generally larger than the optical profile of G3. The reason is as follows. In G2, the quantity of the light incident on photometer 4 out of light L2 from fusion zone 94 can be increased by reflection surface 82 of jig 8. In this manner, the optical profile that reflects the shape of fusion zone 94 can be increased. Accordingly, accuracy in evaluating the laser processing can be improved. The quantity of the light incident on photometer 4 out of light L2 from fusion zone 94 can be increased. Accordingly, influence of disturbance can be reduced, and accuracy of photometer 4 in measuring light L2 by is improved.

As described above, a state of fusion zone 94 can be recognized by measuring the intensity of light L2 from fusion zone 94. Therefore, a state such as the shape of fusion zone 94 formed by the laser processing is measured, and a measurement result of fusion zone 94 is associated with a waveform of an intensity signal from photometer 4. In this manner, processing device 7 can determine whether or not there is an abnormality in fusion zone 94, based on the waveform of the intensity signal from photometer 4. Without being particularly limited, a microscope can be used in measuring the state of fusion zone 94.

More specifically, processing device 7 evaluates the laser processing, based on a comparison between a measurement waveform and a reference waveform. The measurement waveform is a waveform indicating a change in the intensity of light L2 from fusion zone 94 which is measured by photometer 4. The reference waveform includes a normal waveform indicating a change in the intensity of light L2 from fusion zone 94 when there is no abnormality in the laser processing, and one or more abnormal waveforms indicating a change in the intensity of light L2 from fusion zone 94 when there is an abnormality in the laser processing. In this manner, processing device 7 can estimate a fusion state of fusion zone 94, based on the intensity of light L2 from fusion zone 94 which is measured by photometer 4.

Causes of abnormalities in the laser processing include spattering occurrence, fume generation, plasma generation, laser output fluctuations, spot diameter fluctuations, laser irradiation time fluctuations, and work-induced fluctuations.

As an example of defects in the laser welding, there is a defect in a gap between workpieces 91 and 92 which occurs when a plurality of workpieces 91 and 92 are superposed on each other. When superposition welding of welding the plurality of workpieces 91 and 92 on the plurality of workpieces 91 and 92 is performed by irradiating all of these with laser beam L1 in a direction in which the plurality of workpieces 91 and 92 are superposed on the plurality of superposed workpieces 91 and 92, it is preferable that the plurality of workpieces 91 and 92 are in close contact with each other. The reason is as follows. When there is a gap between workpieces 91 and 92 due to deformation of workpieces 91 and 92 affected by heat during the laser processing or distortion of workpieces 91 and 92 before the laser processing, there is a problem such as a joint mistake between workpieces 91 and 92 and insufficient strength of a joint portion. When there is a gap between workpieces 91 and 92, fusion zone 94 penetrates one of workpieces 91, and is brought into a state of being fallen out from the gap. Furthermore, when the gap is formed, the light is scattered in the gap. Accordingly, the shape of fusion zone 94 may be changed, and the width of fusion zone 94 may be narrowed in some cases. Therefore, it is observed that the intensity of the thermal radiation light or the reflection light decreases.

Therefore, in a case of the superposition welding, gap formation between workpieces 91 and 92 can be estimated by a decrease in the intensity of the reflection light. In this case, the decrease in the intensity of the reflection light needs to be measured with high sensitivity.

Processing device 7 detects a state of the emission light or the reflection light of fusion zone 94, based on an image acquired from camera 52.

### 1-3. Advantageous Effect and Others

Laser processing system 1 in FIG. 1 described above includes laser oscillator 20, photometer 4, and jig 8. Laser oscillator 20 forms fusion zone 94 on workpiece 91 by irradiating fusion-scheduled region 95 of processing target surface 93 of workpiece 91 with laser beam L1. Photometer 4 measures intensity of light L2 emitted from fusion zone 94 of workpiece 91. Jig 8 is disposed on processing target surface 93 of workpiece 91 in order to press workpiece 91. Jig 8 has reflection surface 82 inclined away from fusion-scheduled region 95 as reflection surface 82 is away from processing target surface 93 of workpiece 91. In this manner, stable laser processing can be performed, and accuracy in evaluating the laser processing can be improved.

In laser processing system 1 in FIG. 1, reflection surface 82 specularly reflects light L2 from fusion zone 94. In this manner, the quantity of the light incident on photometer 4 out of light L2 from fusion zone 94 can be increased, and accuracy in evaluating the laser processing can be improved.

Laser processing system 1 in FIG. 1 includes optical system 3. Optical system 3 includes condenser lens 31 that faces processing target surface 93 of workpiece 91. Optical system 3 causes condenser lens 31 to condense laser beam L1 from laser oscillator 20 on fusion-scheduled region 95. Optical system 3 directs the light incident on condenser lens 31 out of light L2 from fusion zone 94 toward photometer 4. Reflection surface 82 is inclined to reflect light L2 from fusion zone 94 toward condenser lens 31. In this manner, stable laser processing can be performed.

In laser processing system 1 in FIG. 1, height H1 of reflection surface 82 is equal to or smaller than working distance D2 of condenser lens 31. In this manner, condenser lens 31 and reflection surface 82 can be prevented from interfering with each other, when the irradiation position of laser beam L1 is changed.

In laser processing system 1 in FIG. 1, at least a portion of reflection surface 82 faces a region within effective diameter D1 of condenser lens 31 in a direction along optical axis A1 of condenser lens 31. In this manner, the quantity of the light incident on photometer 4 out of light L2 from fusion zone 94 can be increased, and accuracy in evaluating the laser processing can be improved.

In laser processing system 1 in FIG. 1, when an angle between optical axis A1 of condenser lens 31 and the marginal ray is defined as θ1 degree and an angle of reflection surface 82 with respect to processing target surface 93 is defined as θ2 degree, θ2<90−θ1 is satisfied. In this manner, a possibility that laser beam L1 may touch reflection surface 82 can be reduced.

In laser processing system 1 in FIG. 1, jig 8 has the pair of pressers 81 located on both sides of fusion-scheduled region 95. A surface of each of the pair of pressers 81 on a side of fusion-scheduled region 95 includes reflection surface 82. In this manner, stable laser processing can be performed in line processing with laser beam L1, and accuracy in evaluating the laser processing can be improved.

In laser processing system 1 in FIG. 1, light L2 from fusion zone 94 includes at least one of the thermal radiation light caused by fusion of workpiece 91 irradiated with laser beam L1, the excitation light caused by excitation of workpiece 91 irradiated with laser beam L1, the laser plasma generated by irradiation with laser beam L1, and the reflection light of laser beam L1 reflected by workpiece 91. In this manner, accuracy in evaluating the laser processing can be improved.

Laser processing system 1 in FIG. 1 further includes processing device 7. Processing device 7 performs the laser processing for forming fusion zone 94 by irradiating fusion-scheduled region 95 with laser beam L1 from laser oscillator 20. Processing device 7 performs an evaluation of the laser processing, based on the intensity of light L2 from fusion zone 94 which is measured by photometer 4. In this manner, stable laser processing can be performed, and accuracy in evaluating the laser processing can be improved.

In laser processing system 1 in FIG. 1, the evaluation of the laser processing includes estimating a fusion state of fusion zone 94, based on the intensity of light L2 from fusion zone 94 which is measured by photometer 4. In this manner, it is possible to evaluate the fusion state of fusion zone 94. In particular, the quantity of the light incident on photometer 4 out of light L2 from fusion zone 94 can be increased by laser processing system 1. Accordingly, it is possible to accurately evaluate the fusion state, for example, a welding state. For example, laser processing system 1 can accurately evaluate welding quality. Since laser processing system 1 is used in evaluating the welding quality, it is possible to predict welding abnormalities without depending on a skilled level. Therefore, the number of defects is reduced by making an early response to abnormalities, and it is expected that productivity is improved by reducing a downtime of the device.

Jig 8 described above is disposed on processing target surface 93 of workpiece 91 in order to press workpiece 91 in the laser processing for forming fusion zone 94 in workpiece 91 by irradiating fusion-scheduled region 95 of processing target surface 93 of workpiece 91 with laser beam L1. Jig 8 has reflection surface 82 inclined away from fusion-scheduled region 95 as reflection surface 82 is away from processing target surface 93 of workpiece 91. In this manner, stable laser processing can be performed, and accuracy in evaluating the laser processing can be improved.

### Modification Example

The embodiments of the present disclosure are not limited to the above-described embodiments. The above-described embodiments can be modified in various ways depending on design, as long as the object of the present disclosure can be achieved. Hereinafter, modification examples of the above-described embodiments will be described. The modification examples described below can be applied in appropriate combination with each other.

### 1. Modification Example 1

FIG. 6 is a schematic cross-sectional view of a configuration example of jig 8A of Modification Example 1. Jig 8A has a pair of pressers 81A. Height H1 of reflection surface 82A of presser 81A is higher than height H1 of reflection surface 82 of presser 81 in FIG. 4, and is equal to working distance D2 of condenser lens 31. Even in Modification Example 1, when workpiece 91 is irradiated with laser beam L1, the irradiation position of laser beam L1 can be changed in accordance with the focal position of condenser lens 31. Therefore, when the irradiation position of laser beam L1 is changed, condenser lens 31 and reflection surface 82A can be prevented from interfering with each other. A gap between reflection surface 82A and condenser lens 31 can be reduced. Accordingly, the quantity of the light incident on photometer 4 out of light L2 from fusion zone 94 can be increased, and accuracy in evaluating the laser processing can be improved.

### 2. Modification Example 2

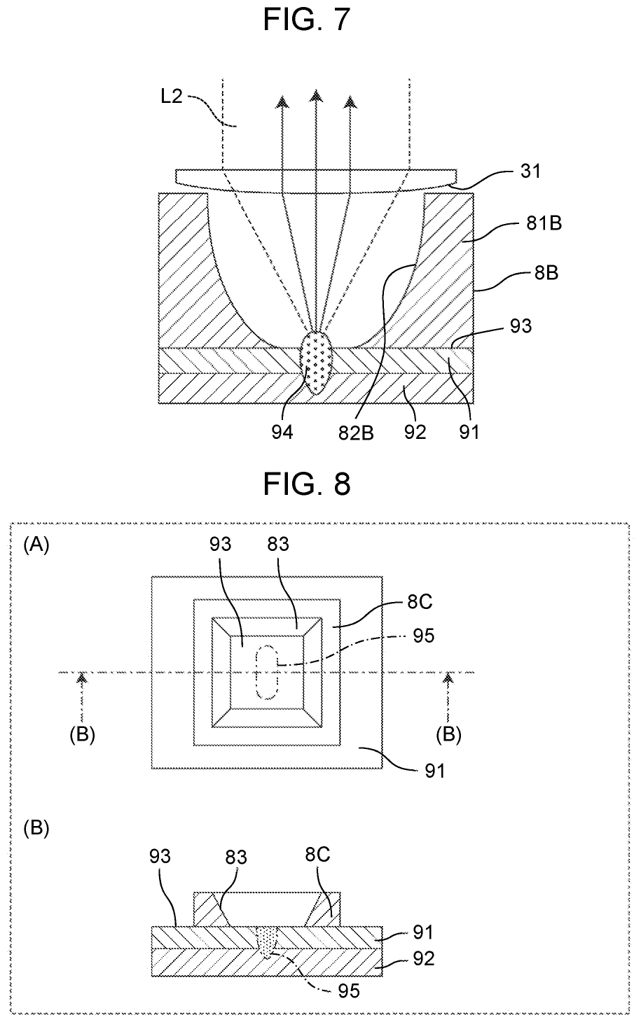

FIG. 7 is a schematic cross-sectional view of a configuration example of jig 8B of Modification Example 2. Jig 8B has a pair of pressers 81B. Reflection surface 82B of presser 81B is not an inclined surface having a constant angle, and is a concave surface having a predetermined curvature. Reflection surface 82B has a substantially arc shape in a cross section orthogonal to a length direction of presser 81B. In the cross section orthogonal to the length direction of presser 81B, a maximum value of an angle between a tangent line of reflection surface 82B and processing target surface 93 is set to 90−θ1. In this manner, the quantity of the light incident on photometer 4 out of light L2 from fusion zone 94 can be increased, and accuracy in evaluating the laser processing can be improved. Reflection surface 82B of presser 81B may be a convex surface instead of the concave surface, and may be a curved surface.

### 3. Modification Example 3

FIG. 8 is a schematic view of a configuration example of jig 8C of Modification Example 3. (A) of FIG. 8 is a plan view illustrating a state where jig 8C is disposed on processing target surface 93 of workpiece 91. (B) of FIG. 8 is a cross-sectional view taken along line VIIIB-VIIIB in (A) of FIG. 8. Jig 8C is a tubular presser that surrounds fusion-scheduled region 95 of processing target surface 93 of workpiece 91. Jig 8C has a quadrangular shape in a plan view. An inner peripheral surface of jig 8C serving as the presser includes reflection surface 83. In FIG. 8, the inner peripheral surface of jig 8C is inclined so that an opening is enlarged as the inner peripheral surface is directed in the normal direction of processing target surface 93. That is, each of four inner surfaces forming the inner peripheral surface of jig 8C is reflection surface 83 inclined in a manner that reflection surface 83 is further away from fusion-scheduled region 95 as reflection surface 83 is further away from processing target surface 93 in the normal direction of processing target surface 93 of workpiece 91. That is, in jig 8C, reflection surface 83 is disposed to surround fusion-scheduled region 95. In this manner, the quantity of the light incident on photometer 4 out of light L2 from fusion zone 94 can be increased, and accuracy in evaluating the laser processing can be improved. For example, fusion-scheduled region 95 as illustrated in FIG. 8 is set when spot processing such as spot welding is performed by using laser beam L1. Therefore, in the spot processing performed by using laser beam L1, stable laser processing can be performed, and accuracy in evaluating the laser processing can be improved. A shape of jig 8C in a plan view is not limited to a quadrangular shape, and may be a polygonal shape in addition to the quadrangular shape. That is, the inner peripheral surface of jig 8C may be configured to include three or more inner surfaces, and at least one of the three or more inner surfaces may be reflection surface 83.

In Modification Example 3, jig 8C has a tubular presser that surrounds fusion-scheduled region 95. The inner peripheral surface of the presser includes reflection surface 83. According to Modification example 3, in the spot processing performed by using laser beam L1, stable laser processing can be performed, and accuracy in evaluating the laser processing can be improved.

### 4. Modification Example 4

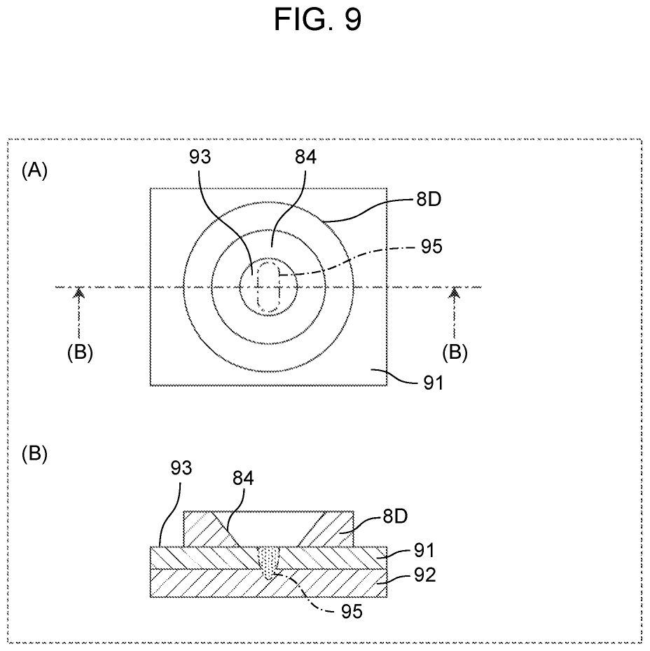

FIG. 9 is a schematic view of a configuration example of jig 8D of Modification Example 4. (A) of FIG. 9 is a plan view illustrating a state where jig 8D is disposed on processing target surface 93 of workpiece 91. (B) of FIG. 9 is a cross-sectional view taken along line IXB-IXB in (A) of FIG. 9. Jig 8D is a tubular presser that surrounds fusion-scheduled region 95 of processing target surface 93 of workpiece 91. Jig 8D has a perfect circular shape in a plan view. An inner peripheral surface of jig 8D serving as the presser includes reflection surface 84. In FIG. 9, the inner peripheral surface of jig 8D is inclined so that an opening is enlarged as the inner peripheral surface is directed in the normal direction of processing target surface 93. That is, the entire inner peripheral surface of jig 8D is reflection surface 84 inclined in a manner that reflection surface 84 is further away from fusion-scheduled region 95 as reflection surface 84 is further away from processing target surface 93 in the normal direction of processing target surface 93 of workpiece 91. That is, in jig 8D, reflection surface 84 surrounds fusion-scheduled region 95. In this manner, the quantity of the light incident on photometer 4 out of light L2 from fusion zone 94 can be increased, and accuracy in evaluating the laser processing can be improved. For example, fusion-scheduled region 95 as illustrated in FIG. 9 is set when spot processing such as spot welding is performed by using laser beam L1. Therefore, in the spot processing performed by using laser beam L1, stable laser processing can be performed, and accuracy in evaluating the laser processing can be improved. A shape of jig 8D in a plan view is not limited to a perfect circular shape, and may be an elliptical shape.

In Modification Example 4, jig 8D has a tubular presser that surrounds fusion-scheduled region 95. An inner peripheral surface of the presser includes reflection surface 84. According to Modification Example 4, in the spot processing performed by using laser beam L1, stable laser processing can be performed, and accuracy in evaluating the laser processing can be improved.

### 5. Other Modification Examples

In another modification example, instead of whole jig 8, a portion of jig 8 may be disposed on processing target surface 93 of workpiece 91 in order to press workpiece 91. In short, jig 8 may be the presser itself disposed on processing target surface 93 of workpiece 91 in order to press workpiece 91, or may have a structure including the presser.

In another modification example, reflection surface 82 may include a plurality of inclined surfaces that are inclined at different angles. Reflection surface 82 may include a plurality of curved surfaces having different curvatures. In short, reflection surface 82 may be inclined to be separated from fusion-scheduled region 95 as the distance from processing target surface 93 of workpiece 91 is increased.

In another modification example, reflection surface 82 may not face the region within effective diameter D1 of condenser lens 31 in the direction along optical axis A1 of condenser lens 31. That is, position P1 of a portion of reflection surface 82 which is closest to fusion-scheduled region 95 may be located outside the region within effective diameter D1 of condenser lens 31. In this case, θ2≥90−θ1 may be satisfied.

Laser processing system 1 in FIG. 1 has a configuration in which light having a plurality of wavelength bands is measured at the same time. However, in this manner, a physical phenomenon occurring during the laser processing can be recognized in detail, based on the light having various wavelength bands. Therefore, it is desirable to select a wavelength band of the optical element such as the mirror and the lens in accordance with a wavelength band of the light to be measured. For example, when the visible light and the thermal radiation light are measured, a wavelength-selective reflective film that transmits the visible light may be formed in the mirror, and the mirror may separately supply the light into the optical sensor that measures the thermal radiation light and the optical sensor that measures the visible light. Since the wavelength-selective reflective film is used, the light having different wavelength bands can be measured at the same time. In another modification example, laser processing system 1 may be configured to measure the light having a single wavelength band.

In laser processing system 1 in FIG. 1, laser beam L1 output from laser oscillator 20 is transmitted to optical column 21 by using laser transmission fiber 22. However, laser beam L1 output from laser oscillator 20 may be transmitted to optical column 21 by using the optical element such as the mirror.

In laser processing system 1 in FIG. 1, workpiece 91 is irradiated with laser beam L1. However, in this case, fusion zone 94 may be formed in a spot shape, or linear fusion zone 94 continuously extending may be formed by performing scanning with laser beam L1. In laser processing system 1 in FIG. 1, the scanning with laser beam L1 can be performed by causing movement device 60 to move stage 6. Movement device 60 may perform the scanning with laser beam L1 by moving optical column 21 instead of stage 6. Optical column 21 or stage 6 can be moved by using a robot instead of movement device 60. The scanning with laser beam L1 can be performed on workpiece 91 by using a galvanomirror.

In another modification example, when fusion zone 94 continuously extending is formed by performing the scanning with laser beam L1, the measurement regions of optical sensors 41, 42, and 43 may be set to include whole fusion-scheduled regions 95 corresponding to fusion zone 94. When the laser processing is performed by performing the scanning with laser beam L1, fusion zone 94 emits the light in response to energy received from laser beam L1, even at the irradiation position in front of the current irradiation position of laser beam L1. Therefore, a region wider than the irradiation position of laser beam L1 is set as the measurement region of the light from fusion zone 94. In this manner, for example, it is possible to detect a phenomenon occurring during the fusion, such as spattering occurrence and the influence of fusion liquid generated until fusion zone 94 is solidified after being irradiated with laser beam L1.

In another modification example, in addition to the intensity of light L2 from fusion zone 94, laser processing system 1 may measure a temperature of fusion zone 94 and a vibration amount of workpiece 91.

In another modification example, a measurement time of the intensity signal acquired from photometer 4 may be compared with an actual processing time obtained by dividing the length of fusion zone 94 of workpiece 91 by a laser processing speed. In this manner, a correlation may be obtained between fluctuations in the intensity signal during the measurement time and a change in the shape of fusion zone 94 during the processing time. In this manner, processing device 7 can quantify the change in the shape of fusion zone 94, based on the fluctuations in the intensity signal obtained from photometer 4. The number of samples measured by photometer 4 requires characteristics of processes of the laser processing in evaluating the laser processing, for example, the sufficient number of samples for identifying a tendency of local values of physical quantities such as the curvature of a curve of the output profile of laser beam L1. Therefore, it is desirable that a sampling cycle (measurement cycle) of photometer 4 is equal to or less than 1/100 of a time required for controlling the output of laser irradiation.

In another modification example, the intensity signal of light L2 from fusion zone 94 is acquired by changing conditions in various ways during the laser processing, and an upper limit value and a lower limit value are set for a value indicated by the intensity signal. In this manner, it is possible to predict or evaluate conditions of the laser processing in a stepwise manner in accordance with the value indicated by the intensity signal. For example, when a hole is formed in fusion zone 94 during the welding, the value indicated by the intensity signal is increased due to instantaneous generation of the light when the hole is formed. Accordingly, a cause can be evaluated on a real-time basis by detecting an instantaneous peak of light L2 from fusion zone 94 during the laser processing. In this case, processing device 7 can determine whether or not there is an abnormality by determining whether or not the value indicated by the intensity signal is present between the upper limit value and the lower limit value.

In another modification example, the waveform of the intensity signal and the fusion state of fusion zone 94 are used as a learning data set. In this manner, through supervised machine learning, it is possible to generate a learned model having learning about a correlation between the waveform of the intensity signal and the fusion state of fusion zone 94. In this case, processing device 7 can determine the fusion state of fusion zone 94 by using the learned model, based on the waveform of the intensity signal obtained from photometer 4.

For example, since the learned model having learning about the correlation between the waveform of the intensity signal measured by optical sensor 41, optical sensor 42, and optical sensor 43 and the measurement result of the shape of fusion zone 94 is used, the shape of fusion zone 94 can be specified, based on the waveform of the intensity signal from optical sensors 41 and 42. For example, in a case of the laser welding, as teacher data, a learning data set is used in which the waveform of the intensity signal from optical sensors 41 and 42 is input and the result of the laser welding is output. For example, the result of the laser welding includes the width, or the length of fusion zone 94, and whether or not to perform the welding. Through the machine learning using the teacher data, it is possible to generate the learned model having learning about the correlation between the waveform of the intensity signal and the result of laser welding.

Since the learned model having learning about the correlation between the waveform of the intensity signal and the phenomenon occurring during the laser processing is used through the machine learning, a state of fusion zone 94 can more accurately be determined. Since the state of fusion zone 94 is displayed on a monitor, the display can lead to activities for improving facilities of laser processing system 1 and conditions of the laser processing. That is, a specific cause of a welding defect and the waveform of the intensity signal of light L2 (including the thermal radiation light, the visible light, and the reflection light) from fusion zone 94 are learned as an example. A physical quantity relating to the fusion state is used as the teacher data set. Through the machine learning, it is possible to generate the learned model having learning about the correlation between the waveform of the intensity signal and the cause of the defect of the laser processing such as the welding defect.

In another modification example, the abnormality of fusion zone 94 and the waveform of the intensity signal are associated with each other, and whether or not there is the abnormality is determined by comparing the intensity signal and a threshold value with each other. In this manner, the cause of the abnormality can be specified. For example, when the value of the intensity signal obtained from the photometer 4 exceeds a predetermined threshold value, processing device 7 can determine the occurrence of the abnormality corresponding to the predetermined threshold value.

### Aspects

As will be apparent from the above-described embodiments and modification examples, the present disclosure includes the following aspects. Hereinafter, reference numerals are assigned in parentheses only to clearly indicate a correspondence with the embodiments.

According to a first aspect, there is provided laser processing system (1) including laser oscillator (20), photometer (4), and jig (8; 8A; 8B; 8C; 8D). Laser oscillator (20) forms fusion zone (94) in workpiece (91) by irradiating fusion-scheduled region (95) on processing target surface (93) of workpiece (91) with laser beam (L1). Photometer (4) measures intensity of light (L2) from fusion zone (94) of workpiece (91). Jig (8; 8A; 8B; 8C; 8D) is disposed on processing target surface (93) of workpiece (91) not to overlap fusion-scheduled region (95). Jig (8; 8A; 8B; 8C; 8D) has reflection surface (82; 82A; 82B; 83; 84) inclined in a manner that reflection surface (82; 82A; 82B; 83; 84) further away from fusion-scheduled region (95) as reflection surface (82; 82A; 82B; 83; 84) is further away from processing target surface (93) in a normal direction of processing target surface (93) of workpiece (91). According to this aspect, stable laser processing can be performed, and accuracy in evaluating laser processing can be improved.

According to a second aspect, laser processing system (1) is provided, based on the first aspect. In the second aspect, reflection surface (82; 82A; 82B; 83; 84) specularly reflects light (L2) from fusion zone (94). According to this aspect, a quantity of light (L2) incident on photometer (4) out of light (L2) from fusion zone (94) can be increased, and accuracy in evaluating the laser processing can be improved.

According to a third aspect, laser processing system (1) is provided, based on the first or second aspect. In the third aspect, laser processing system (1) includes optical system (3) including condenser lens (31) facing processing target surface (93) of workpiece (91). Optical system (3) causes condenser lens (31) to condense laser beam (L1) from laser oscillator (20) on fusion-scheduled region (95), and to direct the light incident on condenser lens (31) out of light (L2) from fusion zone (94) to photometer (4). Reflection surface (82; 82A; 82B; 83; 84) is inclined to cause light (L2) from fusion zone (94) to be reflected toward condenser lens (31). According to this aspect, stable laser processing can be performed.

According to a fourth aspect, laser processing system (1) is provided, based on the third aspect. In the fourth aspect, height (H1) of reflection surface (82; 82A; 82B; 83; 84) is equal to or smaller than working distance (D2) of condenser lens (31). According to this aspect, when an irradiation position of laser beam (L1) is changed, condenser lens (31) and reflection surface (82; 82A; 82B; 83; 84) can be prevented from interfering with each other.

According to a fifth aspect, laser processing system (1) is provided, based on the third or fourth aspect. In the fifth aspect, at least a portion of reflection surface (82; 82A; 82B; 83; 84) faces a region within effective diameter (D1) of condenser lens (31) in a direction along optical axis (A1) of condenser lens (31). According to this aspect, a quantity of light incident on photometer (4) out of light (L2) from fusion zone (94) can be increased, and accuracy in evaluating the laser processing can be improved.

According to a sixth aspect, laser processing system (1) is provided, based on any one of the third to fifth aspects. In the sixth aspect, θ2<90−θ1 is satisfied where θ1 is a degree of an angle between optical axis (A1) of condenser lens (31) and a marginal ray and θ2 is a degree of an angle of reflection surface (82; 82A; 82B; 83; 84) with respect to processing target surface (93). According to this aspect, a possibility that laser beam (L1) may touch reflection surface (82; 82A; 82B; 83; 84) can be reduced.

According to a seventh aspect, laser processing system (1) is provided, based on any one of the first to sixth aspects. In the seventh aspect, jig (8; 8A; 8B) has a pair of pressers (81; 81A; 81B) located on both sides of fusion-scheduled region (95). A surface of each of the pair of pressers (81; 81A; 81B) on fusion-scheduled region (95) side includes reflection surface (82; 82A; 82B). According to this aspect, in line processing performed by using laser beam L1, stable laser processing can be performed, and accuracy in evaluating the laser processing can be improved.

According to an eighth aspect, laser processing system (1) is provided, based on any one of the first to seventh aspects. In the eighth aspect, jig (8C; 8D) has a tubular presser that surrounds fusion-scheduled region (95). An inner peripheral surface of the tubular presser includes reflection surface (83; 84). According to this aspect, in spot processing performed by using laser beam L1, stable laser processing can be performed, and accuracy in evaluating the laser processing can be improved.

According to a ninth aspect, laser processing system (1) is provided, based on any one of the first to eighth aspects. In the ninth aspect, light (L2) from fusion zone (94) includes at least one of thermal radiation light caused by fusion of workpiece (91) irradiated with laser beam (L1), excitation light caused by excitation of workpiece (91) irradiated with laser beam (L1), laser plasma generated by irradiation with laser beam (L1), and reflection light of laser beam (L1) reflected by workpiece (91). According to this aspect, accuracy in evaluating the laser processing can be improved.

According to a tenth aspect, laser processing system (1) is provided, based on any one of the first to ninth aspects. In the tenth aspect, laser processing system (1) further includes processing device (7). Processing device (7) performs laser processing for forming fusion zone (94) by irradiating fusion-scheduled region (95) with laser beam (L1) from laser oscillator (20). Processing device (7) performs evaluation of the laser processing, based on the intensity of light (L2) from fusion zone (94) which is measured by photometer (4). According to this aspect, stable laser processing can be performed, and accuracy in evaluating laser processing can be improved.

According to an eleventh aspect, laser processing system (1) is provided, based on the tenth aspect. In the eleventh aspect, the evaluation of the laser processing includes estimating a fusion state of fusion zone (94), based on the intensity of light (L2) from fusion zone (94) which is measured by photometer (4). According to this aspect, the fusion state of fusion zone (94) can be evaluated.

According to a twelfth aspect, there is provided jig (8; 8A; 8B; 8C; 8D) disposed on processing target surface (93) of workpiece (91) to press workpiece (91), in laser processing for forming fusion zone (94) on workpiece (91) by irradiating fusion-scheduled region (95) of processing target surface (93) of workpiece (91) with laser beam (L1). Jig (8; 8A; 8B; 8C; 8D) has reflection surface (82; 82A; 82B; 83; 84) inclined further away from fusion-scheduled region (95) as reflection surface (82; 82A; 82B; 83; 84) is further away from processing target surface (93) of workpiece (91). According to this aspect, stable laser processing can be performed, and accuracy in evaluating laser processing can be improved.

According to a thirteenth aspect, jig (8; 8A; 8B; 8C; 8D) is provided, based on the twelfth aspect. In the thirteenth aspect, reflection surface (82; 82A; 82B; 83; 84) specularly reflects light (L2) from fusion zone (94). According to this aspect, a quantity of light incident on photometer (4) out of light (L2) from fusion zone (94) can be increased, and accuracy in evaluating the laser processing can be improved.

The second to eleventh aspects can be appropriately modified and applied to the twelfth aspect.

According to the aspects of the present disclosure, stable laser processing can be performed, and accuracy in evaluating the laser processing can be improved.

The present disclosure is applicable to a laser processing system and a jig. Specifically, the present disclosure is applicable to a laser processing system and a jig for laser processing which enable evaluation of laser processing, for example, evaluation of a workpiece manufactured by the laser processing.

What is claimed is:

1. A laser processing system comprising:
a laser oscillator that forms a fusion zone in a workpiece by irradiating a fusion-scheduled region on a processing target surface of the workpiece with a laser beam;
a photometer that measures intensity of light from the fusion zone of the workpiece; and
a jig disposed on the processing target surface of the workpiece not to overlap the fusion-scheduled region,
wherein the jig has a reflection surface inclined in a manner that the reflection surface is further away from the fusion-scheduled region as the reflection surface is further away from the processing target surface in a normal direction of the processing target surface of the workpiece.

2. The laser processing system of claim 1,
wherein the reflection surface specularly reflects the light from the fusion zone.

3. The laser processing system of claim 1, further comprising:
an optical system including a condenser lens facing the processing target surface of the workpiece,
wherein the optical system causes the condenser lens to condense the laser beam from the laser oscillator on the fusion-scheduled region, and to direct the light incident on the condenser lens out of the light from the fusion zone to the photometer, and
the reflection surface is inclined to cause the light from the fusion zone to be reflected toward the condenser lens.

4. The laser processing system of claim 3,
wherein a height of the reflection surface is equal to or smaller than a working distance of the condenser lens.

5. The laser processing system of claim 3,
wherein at least a portion of the reflection surface faces a region within an effective diameter of the condenser lens in a direction along an optical axis of the condenser lens.

6. The laser processing system of claim 3,
wherein θ2<90−θ1 is satisfied,
where θ1 is a degree of an angle between an optical axis of the condenser lens and a marginal ray, and
θ2 is a degree of an angle of the reflection surface with respect to the processing target surface.

7. The laser processing system of claim 1,
wherein the jig has a pair of pressers located on both sides of the fusion-scheduled region, and
a surface of each of the pair of pressers on the fusion-scheduled region side includes the reflection surface.

8. The laser processing system of claim 1,
wherein the jig has a tubular presser that surrounds the fusion-scheduled region, and
an inner peripheral surface of the tubular presser includes the reflection surface.

9. The laser processing system of claim 1,
wherein the light from the fusion zone includes at least one of thermal radiation light caused by fusion of the workpiece irradiated with the laser beam, excitation light caused by excitation of the workpiece irradiated with the laser beam, laser plasma generated by irradiation with the laser beam, and reflection light of the laser beam reflected by the workpiece.

10. The laser processing system of claim 1, further comprising:
a processing device that performs laser processing for forming the fusion zone by irradiating the fusion-scheduled region with the laser beam from the laser oscillator, and performs evaluation of the laser processing, based on the intensity of the light from the fusion zone which is measured by the photometer.

11. The laser processing system of claim 10,
wherein the evaluation of the laser processing includes estimating a fusion state of the fusion zone, based on the intensity of the light from the fusion zone which is measured by the photometer.

12. A jig disposed on a processing target surface of a workpiece not to overlap a fusion-scheduled region of the processing target surface of the workpiece, in laser processing for forming a fusion zone on the workpiece by irradiating the fusion-scheduled region with a laser beam,
wherein the jig has a reflection surface inclined in a manner that the reflection surface is further away from the fusion-scheduled region as the reflection surface is further away from the processing target surface in a normal direction of the processing target surface of the workpiece.

13. The jig of claim 12,
wherein the reflection surface specularly reflects the light from the fusion zone.
